(19) United States
(12) Patent Application Publication
(10) Pub. No.: US 2018/0006538 A1
(43) Pub. Date: Jan. 4, 2018

(54) ELECTRIC MOTOR

(71) Applicant: The Hong Kong Polytechnic University, Kowloon (HK)

(72) Inventors: Ming LIU, Kowloon (HK); Hon Lung CHAN, Kowloon (HK); Ka Wing CHAN, Kowloon (HK); Junwei LIU, Kowloon (HK); Wenzheng XU, Kowloon (HK)

(73) Assignee: The Hong Kong Polytechnic University, Kowloon (HK)

(21) Appl. No.: 15/198,333

(22) Filed: Jun. 30, 2016

(51) Int. Cl. H02K 19/12; H02K 1/24; H02K 1/14

(52) U.S. Cl. CPC H02K 19/12; H02K 1/14; H02K 1/24

(57) ABSTRACT

An electric motor comprising a stator and a rotor. The stator has at least one resonant circuit and the rotor has at least one resonant circuit rotatable with the rotor relative to at least one stator resonant circuit such that at least one rotor resonant circuit is angularly displaceable relative to at least one stator resonant circuit. At least one stator resonant circuit and at least one rotor resonant circuit are configured to have at least substantially the same self-resonant frequency. The electric motor uses magnetic resonant coupling between one or more stator resonant circuits and one or more rotor resonant circuits to produce usable torque.

### FIELD OF THE INVENTION

The present invention relates to electric motors and, in particular, magnetic resonant coupling motors.

### BACKGROUND OF THE INVENTION

Electric motors have a wide range of applications in a diverse range of industries including automotive, machine tools, fans, refrigerators, pumps, industrial equipment and even toys. In recent times, there has been a particular focus on electric motors in the automotive industry. One of the key reasons for this is the global push to reduce worldwide carbon emissions. Due to expected increases in global temperatures, which are believed to be directly related to carbon emissions, conventional internal combustion engines that derive their energy from fossil fuels are responsible for a large proportion of greenhouse gas emissions and are gradually being replaced by electric motors in electric vehicles.

Electric vehicles have a number of advantages over conventional internal combustion engine vehicles. From an efficiency point of view, the efficiency of converting fuel energy to power at the wheels for electric vehicles is about 60%, while that for conventional internal combustion engine vehicles is approximately 20%. In addition, carbon dioxide emissions from electric vehicles are only 30% to 50% of internal combustion engine vehicles. Besides that, as fossil fuels are a finite resource and will inevitably run out, internal combustion engine vehicles will ultimately have to be replaced by alternative fuel vehicles. Electric vehicles are currently seen by many as the most viable and promising substitute for future transport use due to the simple structure and high energy efficiency. Currently, two of the most commonly used types of electric motors in electric vehicles are switched reluctance motors (SRM) and permanent magnet synchronous motors (PMSM).

An SRM typically comprises a stator having a plurality of stator poles which encircle a rotor comprising iron laminates. When a stator pole is energised to create a magnetic field, the stator pole attracts the iron rotor thereby forcing the rotor to rotate towards the energised pole. By energising consecutive stator poles in sequence, it is possible to maintain rotation of the rotor within the stator. A problem with SRMs is that they are based on a double salient structure which causes significant acoustic noise compared with other machines. Furthermore, because an SRM uses attractive forces only to drive the rotor to rotate, it suffers from torque ripple and low power density.

A PMSM is a cross between an induction motor and a brushless DC motor and comprises a permanent magnet rotor encircled by a stator comprising a plurality of stator poles with windings. Unlike an SRM, PMSM's have high power density. For example, increasing the shaft speed of a PMSM can increase its power level. However, increasing the shaft speed and, hence, rotational speed can give rise to large centrifugal forces on the rotor and its various elements that can cause the motor to crash. A further disadvantage of a PMSM is that it requires relatively expensive permanent magnets which limit the power level (typically tens of kilowatts) and which also suffer from demagnetisation when subjected to high temperatures.

Therefore, there is a need for an electric motor with reduced torque ripple, lower cost of manufacture and higher power density.

It is an object of the present invention to provide an improved electric motor.

### SUMMARY OF THE INVENTION

In accordance with a first aspect of the present invention, there is provided an electric motor comprising a stator and a rotor, wherein the stator comprises at least one resonant circuit and the rotor comprises at least one resonant circuit rotatable with the rotor relative to at least one stator resonant circuit such that at least one rotor resonant circuit is angularly displaceable relative to at least one stator resonant circuit, wherein at least one stator resonant circuit and at least one rotor resonant circuit are configured to have substantially the same self-resonant frequency.

Advantageously, an electric motor according to the present invention can create both attractive and repulsive forces between a stator resonant circuit and a rotor resonant circuit in the motor operation which significantly reduces torque ripple. Furthermore, an electric motor according to the present invention does not require ferromagnetic material to operate and will does not therefore suffer from flux saturation problems. Additionally, since no ferromagnetic material or expensive permanent magnets are required, an electric motor according to the present invention lighter in weight and lower in manufacture cost than existing electric motor designs. Further still, the power level of an electric motor according to the present invention is theoretically unlimited.

At least one stator resonant circuit may be operable to generate an alternating magnetic field in response to a supplied alternating current, and the frequency of the alternating current may be varied as the angular displacement of a rotor resonant circuit changes relative to a stator resonant circuit.

At least one rotor resonant circuit and at least one stator resonant circuit may be configured to resonate at two different frequencies above a critical coupling coefficient for each angular displacement, one frequency being a high resonant splitting frequency which is higher than the self-resonant frequency and one resonant frequency being a low resonant splitting frequency which is lower than the self-resonant frequency.

A stator resonant circuit and an adjacent rotor resonant circuit may be magnetically resonantly couplable to form a pole pair, and wherein an alternating current is supplied to the stator resonant circuit at the low resonant splitting frequency when it is desired to move the rotor resonant circuit toward the stator resonant circuit of the pole pair.

A stator resonant circuit and an adjacent rotor resonant circuit may be magnetically resonantly couplable to form a pole pair, and wherein an alternating current is supplied to the stator resonant circuit at the high resonant splitting frequency when it is desired to move the rotor resonant circuit away from the stator resonant circuit of the pole pair.

The frequency of the alternating current may be adjusted during operation of the electric motor according to the angular displacement of the rotor resonant circuit relative to the stator resonant circuit of the pole pair.

The electric motor may comprise a plurality of stator resonant circuits each configured to have at least substantially the same self-resonant frequency. The electric motor may comprise a plurality of rotor resonant circuits each configured to have at least substantially the same self-resonant frequency.

The stator may comprise at least one stator salient pole and the rotor comprises at least one rotor salient pole, and wherein each stator salient pole is associated with a stator resonant circuit and each rotor salient pole is associated with a rotor resonant circuit.

Each stator resonant circuit may comprise a winding and a capacitor, each winding being wound around a corresponding stator salient pole in the same direction. Each rotor resonant circuit may comprise a winding and a capacitor, each winding being wound around a corresponding rotor salient pole in the same direction.

The electric motor may comprise a plurality of stator resonant circuits and a plurality of rotor resonant circuits, and wherein each rotor resonant circuit may be arranged relative to a stator resonant circuit to form a pole pair which is magnetically resonantly coupled.

The plurality of stator resonant circuits may be divided into two or more sets which are interleaved, and the two or more sets may be alternately energised depending on the angular displacement of the rotor resonant circuits relative to the stator resonant circuits.

One or more rotor resonant circuits may be closed circuits and/or more than one rotor resonant circuit may together form a closed circuit. The stator salient poles may be in circular distribution with the same angular interval. The stator salient poles may have the same shape. The stator salient poles may be the same size. The stator pole windings may have the same number of turns. The stator pole windings may have the same value of inductance.

The rotor salient poles may be in circular distribution with the same angular interval. The rotor salient poles may have the same shape. The rotor salient poles may have the same size. The rotor pole windings may have the same number of turns. The rotor pole windings may have the same value of inductance.

One of the stator resonant circuits and one of the rotor resonant circuits may form a magnetic resonant coupling system, and electrical energy may be transmitted from the stator resonant circuit to the coupled rotor resonant circuit.

According to a second aspect of the present invention, there is provided an electric motor system comprising an electric motor; a sensor arrangement; and a drive circuit arrangement; wherein the electric motor comprises a stator and a rotor, wherein the stator comprises at least one resonant circuit and the rotor comprises at least one resonant circuit rotatable with the rotor relative to at least one stator resonant circuit such that at least one rotor resonant circuit is angularly displaceable relative to at least one stator resonant circuit, wherein at least one stator resonant circuit and at least one rotor resonant circuit are configured to have at least substantially the same self-resonant frequency; the sensor arrangement is operable to measure the position of the rotor relative to the stator; and the drive circuit arrangement is operable to generate a drive signal based upon the measured position to drive the electric motor to operate.

The sensor arrangement may be further operable to measure the speed of rotation of the rotor and/or the electric current supplied to each stator resonant circuit.

The drive circuit may be operable to vary the frequency of the alternating current supplied to one or more stator resonant circuits depending on the measured position of the rotor relative to the stator.

The electric motor may comprise a plurality of stator resonant circuits and the drive circuit may be operable to energise one or more stator resonant circuits at different times during operation of the electric motor depending on the measure position of the rotor relative to the stator.

According to a third aspect of the present invention, there is provided a vehicle comprising an electric motor according to the first aspect.

According to a fourth aspect of the present invention, there is provided a method of operating an electric motor which comprises a stator having at least one resonant circuit and a rotor having at least one resonant circuit, wherein at least one stator resonant circuit and at least one rotor resonant circuit are configured to have substantially the same self-resonant frequency, the method comprising the steps of: energising a stator resonant circuit at a frequency to generate a resonant current in an adjacent rotor resonant circuit and varying the frequency depending on the angular displacement of the adjacent rotor resonant circuit relative to the stator resonant circuit.

The frequency may be a low resonant splitting frequency which is below the self-resonant frequency when it is desired to create an attractive force between at least one stator resonant circuit and an adjacent rotor resonant frequency to force the rotor to rotate in a direction toward the stator resonant circuit.

The frequency may be a high resonant splitting frequency which is above the self-resonant frequency when it is desired to create a repulsive force between at least one stator resonant circuit and an adjacent rotor resonant frequency to force the rotor to rotate in a direction away the stator resonant circuit.

The frequency may be changed from below the self-resonant frequency to above the self-resonant frequency when a rotor resonant circuit passes a stator resonant circuit.

Each stator resonant circuit may comprise a winding having a longitudinal axis and each rotor resonant circuit may comprise a winding having a longitudinal axis and a rotor resonant circuit may be determined to pass a stator resonant circuit when the longitudinal axis of the rotor resonant circuit passes through the longitudinal axis of the stator resonant circuit.

The method may further comprise measuring the position of the rotor relative to the stator and varying the frequency depending on the measured position.

For an electric motor comprising a plurality of stator resonant circuits, the method may further comprise the steps of: energising a first stator resonant circuit when a rotor resonant circuit is at a position which is closer to the first stator resonant circuit than an adjacent second stator resonant circuit which is not energised, and ceasing to energise the first stator resonant circuit and energising the adjacent second stator resonant circuit when the rotor resonant circuit is at a position which is closer to the second stator resonant circuit than the first stator resonant circuit.

The second stator resonant circuit may be energised and the first stator resonant circuit may be de-energised when the rotor resonant circuit moves beyond a position which is equidistant between the first stator resonant circuit and the second stator resonant circuit.

### BRIEF DESCRIPTION OF THE DRAWINGS

Preferred embodiments of the present invention will be explained in further detail below by way of examples and with reference to the accompanying drawings, in which:

FIG. 1 shows a schematic representation of a motor according to the present invention;

FIG. 2 shows a circuit diagram of two resonant circuits of a pole pair comprising a stator pole and a rotor pole shown in FIG. 1 as outlined by broken lines;

FIG. 3 shows a block diagram of a magnetic resonant coupling motor system comprising an electric motor according to the present invention;

FIG. 4 shows a photograph of hardware of the system shown in FIG. 3;

FIG. 5 shows a circuit diagram of components used in the system shown in FIGS. 3 and 4;

FIG. 6 shows a chart of the phase angle between respective resonant currents in the resonant circuits of the pole pair shown in FIG. 1 against the coupling frequency between the two resonant circuits shown in FIG. 2;

FIG. 7 shows a three dimensional chart of the relationship between the amplitude of the resonant current in the resonant circuit of the rotor shown in FIGS. 1 and 2, the coupling frequency between the two resonant circuits and the coupling coefficient;

FIG. 8 shows the chart shown in FIG. 4 from a different perspective;

FIG. 9 shows a chart of the relationship of the resonant current in the resonant circuit of the stator pole shown in FIG. 1 against the angular displacement between the stator pole and the rotor pole;

FIG. 10 shows a chart of the relationship of the resonant current in the resonant circuit of the rotor pole shown in in FIG. 1 against the angular displacement between the stator pole and the rotor pole;

FIG. 11 shows a chart of the phase angle between respective resonant currents in the resonant circuits of the pole pair shown in FIG. 1 against the angular displacement between the stator pole and the rotor pole of the pole pair;

FIG. 12 shows a chart of the optimum coupling frequency of the resonant circuits of the pole pair shown in FIG. 1 against the angular displacement between the pole pair;

FIG. 13 shows the polarity of the stator pole and the rotor pole of the pole pair shown in FIG. 1 as the rotor pole rotates in an anticlockwise direction toward the stator pole;

FIG. 14 shows the polarity of the stator pole and the rotor pole of the pole pair shown in FIG. 1 as the rotor pole rotates in an anticlockwise direction away from the stator pole;

FIG. 15 shows a computer generated simulation of the magnetic field strengths of the stator pole and the rotor pole as the rotor pole rotates in an anticlockwise direction toward the stator pole; and

FIG. 16 shows a computer generated simulation of the magnetic field strengths of the stator pole and the rotor pole as the rotor pole rotates in an anticlockwise direction away from the stator pole.

### DETAILED DESCRIPTION OF THE PREFERRED EMBODIMENTS

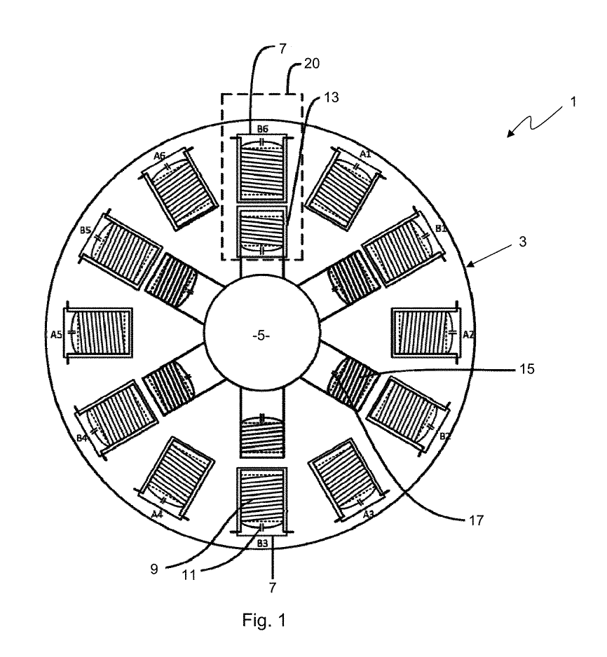

Referring to the drawings, FIG. 1 shows a magnetic resonant coupling motor or electric motor 1 comprising a stator 3 and a rotor 5. The stator 3 comprises twelve substantially cylindrical stator salient poles 7 having a radius of approximately 0.03 m and a length of approximately 0.05 m. The stator salient poles 7 are arranged in a ring such that the longitudinal axis of each stator salient pole 7 is directed toward the approximate centre of the stator 3. The stator salient poles 7 are equally spaced apart about the centre of the stator 3 such that the angle between the longitudinal axes of two adjacent stator poles is 30°. The stator 3 is chosen to have an inner diameter of approximately 0.245 m as measured from the inner extremity of one stator salient pole 7 to the inner extremity of another stator salient pole 7 on the opposite side respectively of the stator 3.

The stator salient poles 7 are made from a non-ferromagnetic material such as Bakelite® or reinforced, rigid plastics material. A length of copper wire with a diameter of approximately 0.00142 m is wound around each stator salient pole 7 respectively in the same direction each with ninety six turns to form a stator pole winding 9 on each stator salient pole 7. Other numbers of turns may be chosen as will be apparent to a person of ordinary skilled in the art. In the embodiment depicted, each stator salient pole winding 9 is configured to have an inductance of approximately 0.432 mH and has an internal equivalent series resistance R₁ of approximately 1.15Ω.

Each stator pole winding 9 of each stator salient pole 7 is connected in series to a corresponding resonant capacitor 11 having a capacitance of approximately 0.147 μF to form a resonant circuit or tank circuit 12, hereinafter ‘stator pole circuit’. Thus, in the embodiment depicted, there are twelve independent stator pole circuits each associated with a corresponding stator salient pole 7. Each stator pole circuit is connected to an AC power source to energise the circuit 12.

With further reference to FIG. 1, the rotor 5 is fixedly mounted to a shaft which supports the rotor 5 for rotation within the stator 3. The rotor 5 comprises six substantially cylindrical rotor salient poles 13 made from Bakelite or rigid plastics material each of length approximately 0.03 m and radius approximately 0.03 m. The outside diameter of the rotor 5, as measured from the extreme end of one rotor salient pole 13 to the extreme end of a rotor pole on the opposite side respectively of the rotor 5, is chosen to be approximately 0.24 m. Thus, there is a clearance of approximately 0.025 m between an end of a stator salient pole 7 and an end of an adjacent rotor salient pole 13 when their respective longitudinal axes are aligned.

A length of copper wire with a diameter of approximately 0.001 m is wound around each rotor salient pole 13 in the same direction two hundred and eighty times to form a rotor pole winding 15 on each rotor salient pole 13 having an inductance of approximately 4.054 mH and an internal equivalent series resistance R₂ of approximately 5.12Ω. Each rotor pole winding 15 is connected in series to a corresponding resonant capacitor 17 having a capacitance of approximately 0.0157 μF to form an independent closed resonant circuit or tank circuit 19, hereinafter ‘rotor pole circuit’. Thus, in the embodiment depicted there are six independent closed rotor pole circuits each associated with a corresponding rotor salient pole 13.

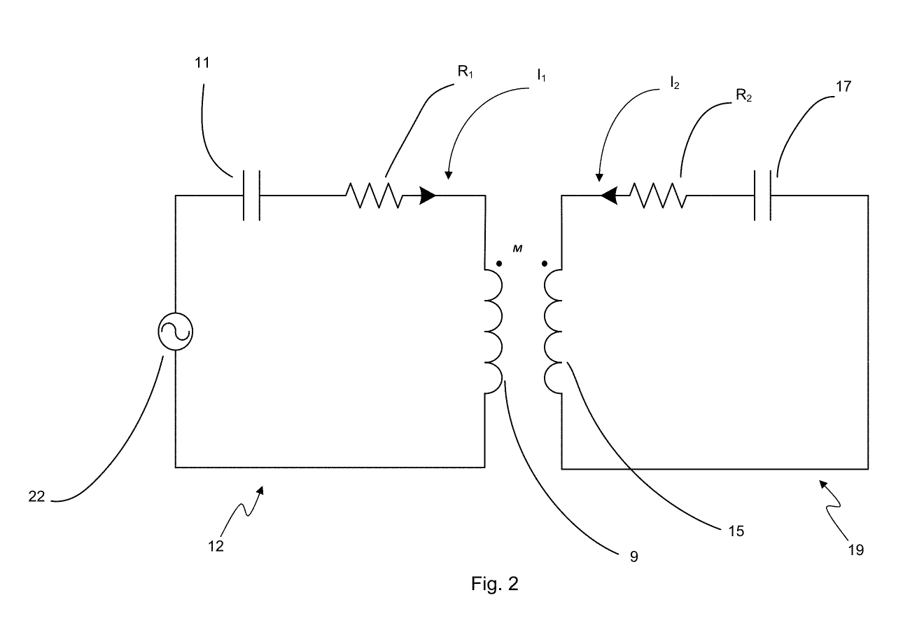

With reference to FIGS. 1 and 2, a stator salient pole 7 and a rotor salient pole 13 may form a pole pair 20 which interact with one another when the rotor salient pole 13 is in proximity to the stator salient pole 7. Each stator pole circuit 12 and each rotor pole circuit 19 is configured to have substantially the same self-resonant frequency such that they resonant at a common frequency. Thus, a stator pole circuit 12 of a pole pair 20 is a transmitter circuit and a rotor pole circuit 19 of a pole pair 20 is a receiver circuit so that electrical energy may be wirelessly transmitted from the transmitter circuit to the receiver circuit at resonant frequencies. Since there are twelve stator salient poles 7 and six rotor salient poles 13, six coupled pole pairs 20 may be formed upon rotation of the rotor 5 relative to the stator 3

With reference to FIG. 2 depicting the circuit model of a pole pair 20, a changing magnetic field is generated by the stator pole winding 9 of the stator pole circuit 12 when excited by an external AC power source 22 with a resonant current I₁. The rotor pole circuit 19 picks up the magnetic energy from the magnetic field of the stator pole circuit 12 using wireless power transfer. This magnetic energy generates a resonant current I₂ in the rotor pole winding 15 which in turn generates a second changing magnetic field by mutual inductance. The magnetic fields generated by the stator pole circuit 12 and rotor pole circuit 19 interact with each other and a resultant magnetic force is developed to drive the rotor 5 to rotate relative to the stator 3.

For a pole pair 20 where the stator pole winding 9 has an inductance L₁ and the rotor pole winding 15 has an inductance L₂, the mutual inductance M can be described by the equation:

M=k\sqrt{L₁L₂}

where k is the coupling coefficient which is a measure of the amount of magnetic flux produced by the stator pole winding 9 that passes through the rotor pole winding 15. For a pole pair 20, the coupling coefficient k is dependent upon the angular displacement of the rotor salient pole 13 relative to the stator salient pole 7.

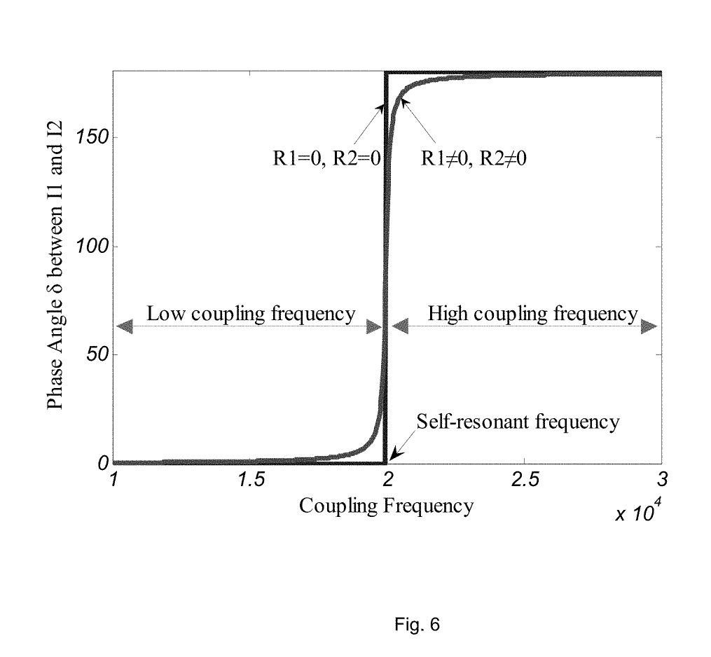

With reference to FIG. 6, the relationship between the phase angle δ between the resonant current I₁ in the stator pole winding 9 and the resonant current I₂ in the rotor pole winding 15 and the coupling frequency for a given coupling coefficient k is shown. For an ideal case where the internal resistance of the stator pole winding 9 and rotor pole winding 15 is zero, it can be seen that, below the self-resonant frequency, the phase angle is 0° and, above the self-resonant frequency, 180°. However, in practice, as outlined above, the stator pole windings 9 and the rotor pole windings 15 have an internal equivalent series resistance of R₁ and R₂ respectively. Therefore, where R₁ and R₂>0Ω, the relationship between the phase angle and the coupling frequency for a given coupling coefficient k may be described by the following equation:

$$δ = {tan}^{- 1} \frac{{R}_{2} + j ω {L}_{2} - \frac{1}{j ω {C}_{2}}}{- j ω M}$$

where R₂ is the internal equivalent series resistance of the rotor pole winding 15, L₂ is the inductance of the rotor pole winding 15, C₂ is the capacitance of the rotor capacitor 17, M is the mutual inductance and ω is the angular frequency. A plot of the relationship between phase angle and coupling frequency for a given coupling coefficient where R₁ and R₂≠0Ω is also shown on the chart of FIG. 6. Since it can be seen from the above equation that the greater the internal resistance R₂, the greater the phase angle between I₁ and I₂, it is desirable to keep the internal resistance low.

As stated above, the self-resonant frequencies of the stator pole circuit 12 and the rotor pole circuit 19 are configured to be the same and may be described by the following equation:

$$2 π {f}_{0} = {ω}_{0} = \frac{1}{\sqrt{{L}_{1} {C}_{1}}} = \frac{1}{\sqrt{{L}_{2} {C}_{2}}}$$

where L₁ and C₁ and L₂ and C₂ are the inductances and capacitances of the stator pole circuit 12 and rotor pole circuit 19, respectively. Using the above parameters of the example embodiment, the self-resonant frequency is approximately 19.97 kHz.

If the excitation frequency is at the self-resonant frequency f₀, the phase angle between I₁ and I₂ is invariably 90° and, in this condition, no force will be developed on the pole pair. Furthermore, with reference to FIG. 6, when the coupling frequency is below the self-resonant frequency f₀, the respective resonant currents of the stator pole winding 9 and the rotor pole winding 15 are nearly in phase; and the respective resonant currents are almost 180° out of phase when the coupling frequency is above the self-resonant frequency f₀.

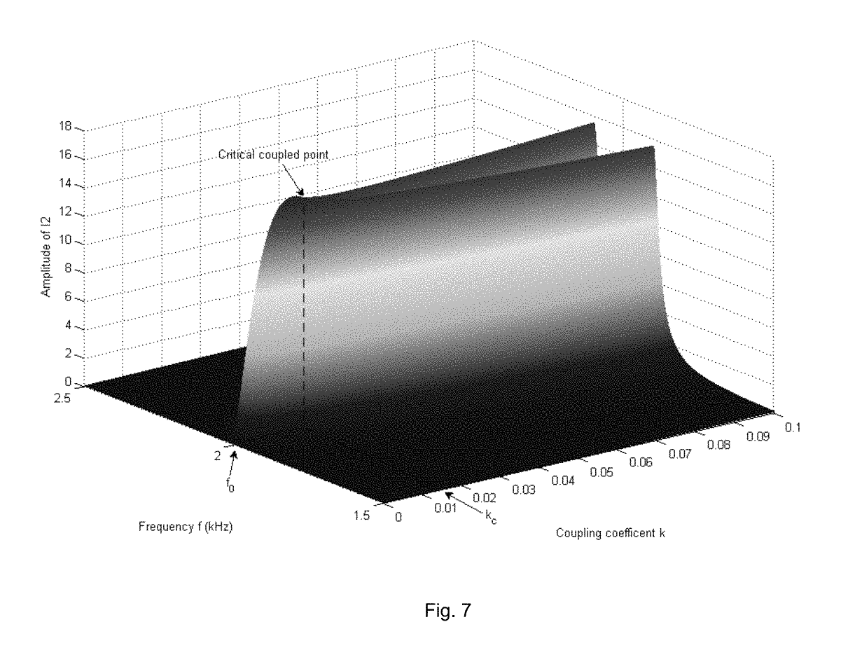

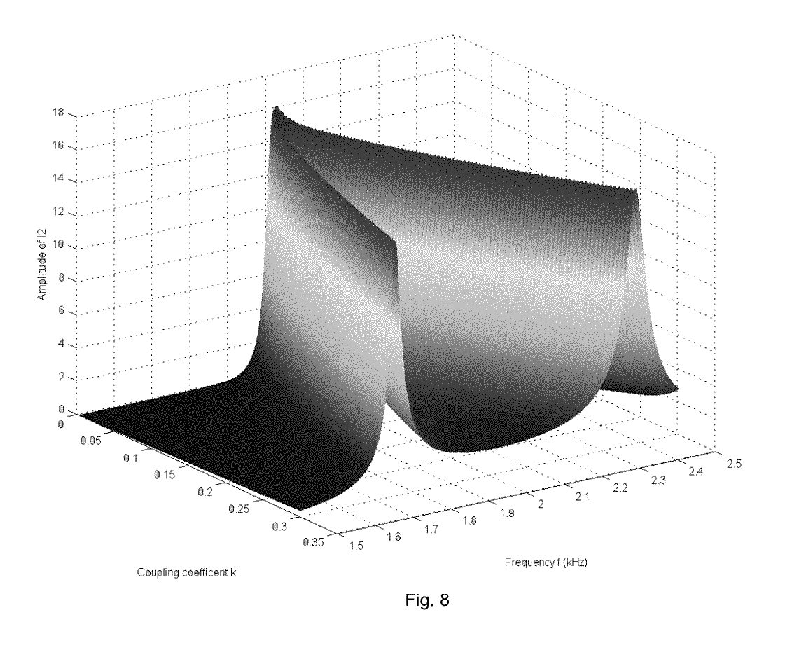

Turning to FIGS. 7 and 8 which show the relationship of the resonant current I₂ in the rotor pole winding 15 with the coupling frequency and the coupling coefficient, it can be observed that a splitting phenomenon exists in practice for windings with internal resistance such that the highest level of wireless power transfer from the stator pole circuit 12 to the rotor pole circuit 19 can be achieved with two sets of frequencies, namely a set of low resonant splitting frequencies and a set of high resonant splitting frequencies. Assuming the internal resistances of the stator pole windings 9 and the rotor pole windings 15 are much smaller than the resonant impedances:

$${R}_{i} ≪ ω {L}_{i} and {R}_{i} ≪ \frac{1}{ω {C}_{i}} ,$$

where i=1 or 2, two resonant splitting frequencies can be calculated as follows:

$$2 π {f}_{L} = {ω}_{L} = \frac{{ω}_{0}}{\sqrt{1 + k}} , 2 π {f}_{H} = {ω}_{H} = \frac{{ω}_{0}}{\sqrt{1 - k}}$$

where f_{L} is the low resonant splitting frequency and f_{H} is the high resonant splitting frequency.

For a pole pair 20, each angular displacement corresponds to a particular coupling coefficient k. Furthermore, there is a critical coupled point with a critical

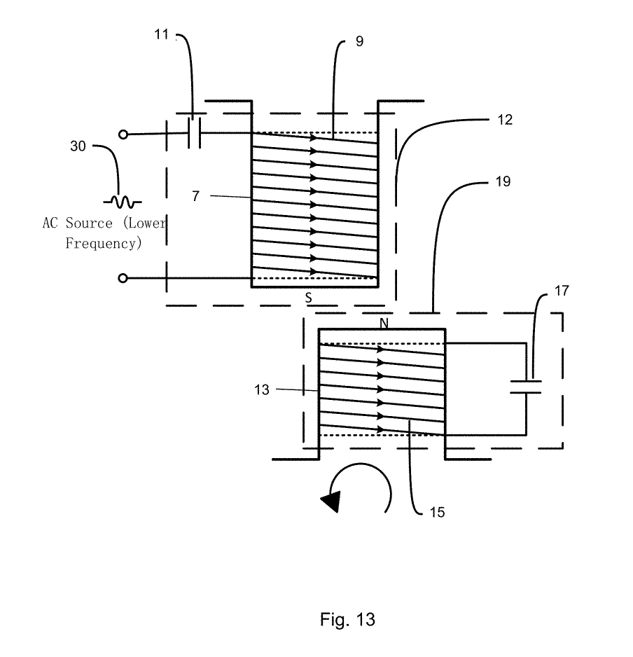

Referring to FIG. 13, when the rotor pole 13 moves, for example, anticlockwise relative to the stator pole 7 from an angular displacement of −15° to 0° it is desirable to generate attractive forces to maintain rotation of the rotor 5. Thus, the stator pole circuit 12 is driven at optimum low resonant splitting frequencies by an AC power supply 30, which is within the bandwidth for attractive forces, to create a resonant current I₁ in the stator pole winding 9. The resonant current I₁ creates a changing magnetic field, which magnetically couples with the rotor pole winding 15 and generates a resonant current I₂ in the rotor pole winding 15. Since the resonant current I₂ generated in the rotor pole circuit 19 at low resonant splitting frequencies is substantially in phase with the resonant current I₁ in the stator pole circuit, the polarity of magnetic force created at the interfacing ends of the respective poles are opposite and therefore attractive. Thus, a resultant magnetic force is developed that drives the rotor pole 13 toward the stator pole 7.

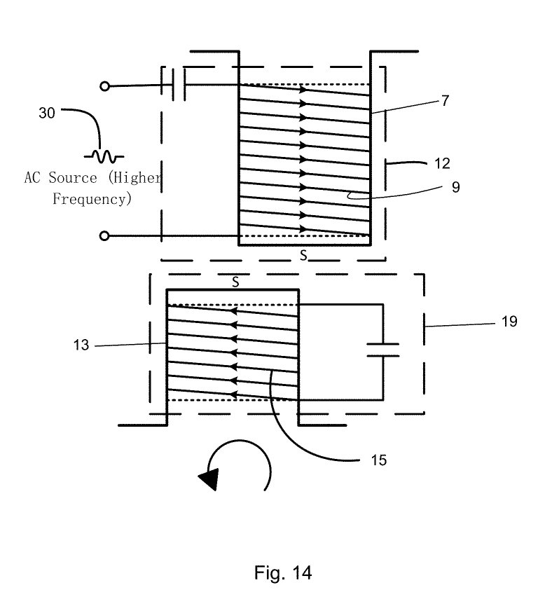

Turning to FIG. 14, as the rotor pole 13 passes the stator pole 7 and is thus moving from an angular displacement of 0° to +15°, it is desirable to create repulsive forces. Thus, the stator pole circuit 12 is driven at optimum high resonant splitting frequencies by the AC power source 30, which is within the frequency band for a repulsive force, to generate a resonant current I₁ flowing through the stator pole winding 9. The resonant current I₁ in the stator pole winding 9 generates a changing magnetic field that couples with the rotor pole winding 15 to generate a resonant current I₂ in the rotor pole circuit 19. Since at high resonant splitting frequencies the resonant current I₂ generated in the rotor pole circuit 19 is substantially out of phase with the resonant current I₁ in the stator pole circuit 12, the polarity of magnetic force created at the interfacing ends of the respective poles 7, 13 are like and therefore repulsive. Thus, a resultant magnetic force is developed that drives the rotor pole 13 away from the stator pole 7.

Although, the coupling frequency varies with the angular displacement, the magnetic polarity of the stator poles 7 is invariable. It is the magnetic polarity of the coupling efficient k_{c} below which the splitting phenomenon disappears. The critical coupling coefficient k_{c} may be may be described by the following equation:

$${k}_{c} = \sqrt{\frac{{R}_{1} {R}_{2}}{{ω}_{0}^{2} {L}_{1} {L}_{2}}} = \frac{1}{\sqrt{{Q}_{1} {Q}_{2}}}$$

where Q₁ and Q₂ are the quality factor of stator pole winding and rotor pole winding respectively. For example, substituting the parameters for the above described embodiment, k_{c} may be calculated as 0.0146.

As the total allowable angular displacement for a rotor pole to migrate from one stator pole to another stator pole is

$$\frac{360 °}{number of stator pole} = \frac{360 °}{12} = 30 ° ,$$

or ±15° relative to a stator pole, the coupling coefficient k between ±15° must be greater than k_{c} to achieve resonant splitting and maximum wireless power transfer from the stator pole circuit 12 to the rotor pole circuit 15 and, thereby, achieve maximum attractive or repulsive forces between the stator pole 7 and the rotor pole 13 for each angular displacement.

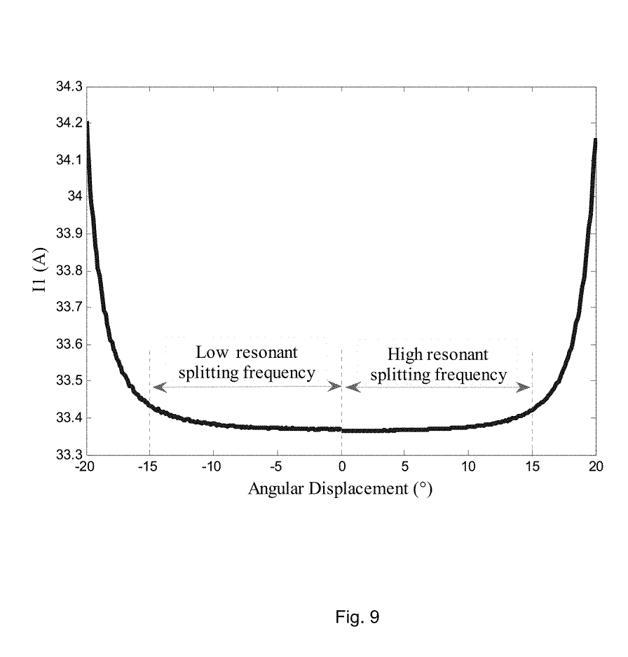

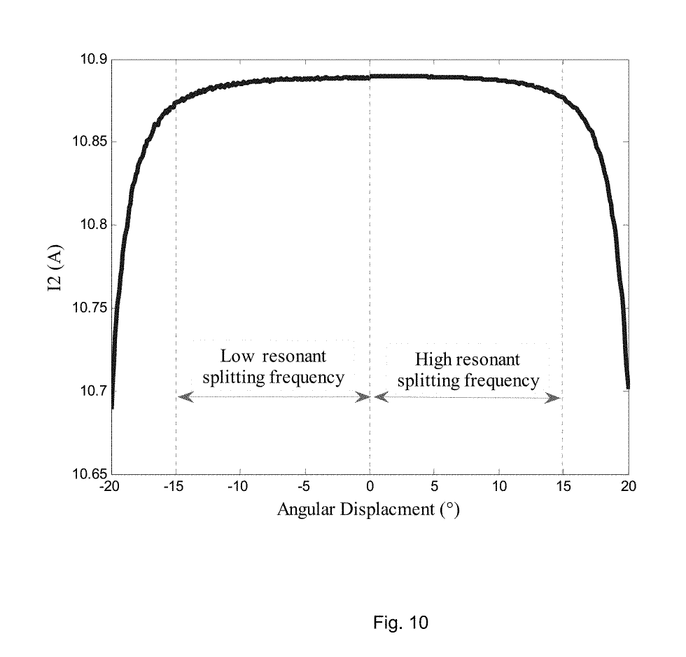

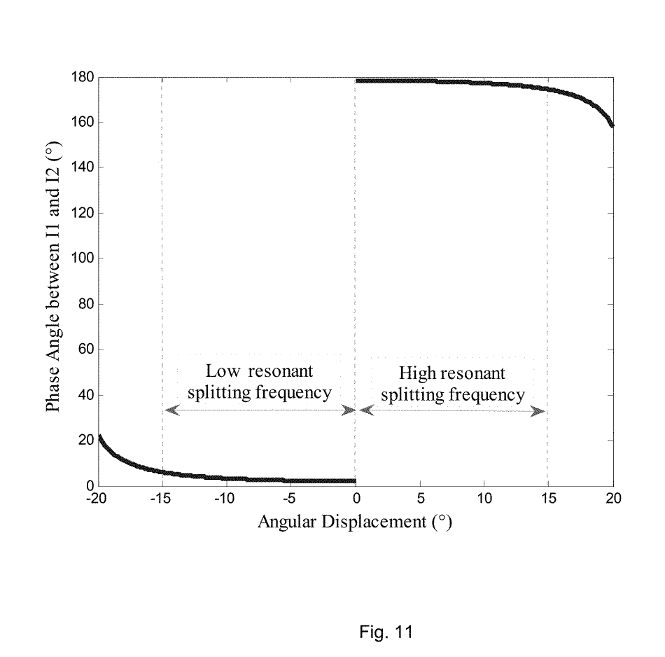

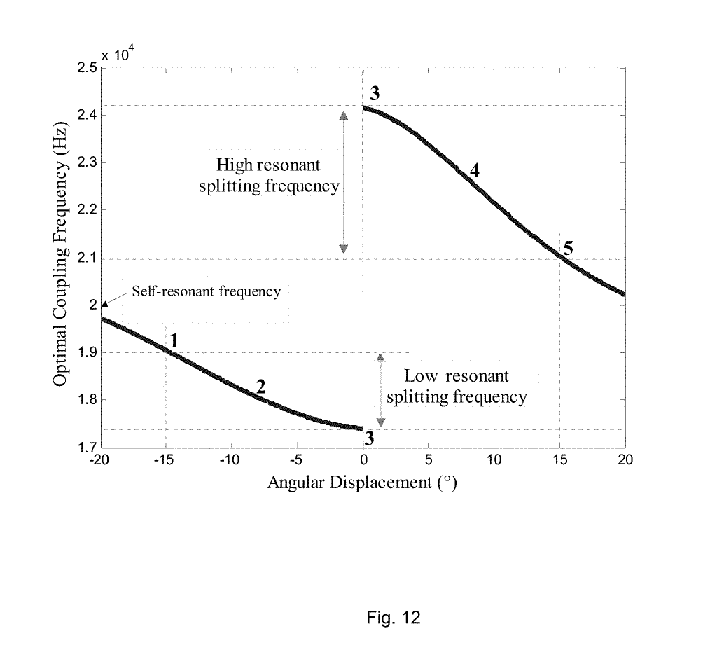

Turning to FIGS. 9 and 10, it can be observed that the resonant current I₂ generated in the rotor pole circuit 19 by mutual inductance with the stator pole circuit 12 is maximised and relatively constant between ±15° when the stator pole circuit 12 is excited by low and high resonant splitting frequencies as dependent on the angular displacement. With reference to FIG. 11, it can also be observed that the phase angle between I₁ and I₂ is close to 0° (i.e. substantially in phase) at angular displacements between 0° and −15° when the stator pole circuit is driven at low resonant splitting frequencies, and close to 180° (i.e. substantially out of phase) at angular displacements between 0° and +15° when the stator pole circuit is driven at high resonant splitting frequencies. Referring to FIG. 12, for each angular displacement, there is an optimum coupling frequency for maximum power transfer which is either a low resonant splitting frequency at an angular displacement of between 0° and −15° or a high resonant splitting frequency at an angular displacement of between 0° and +15°.

rotor poles 13 that will reverse due to changes in the phase angle between the resonant currents I₁, I₂, by switching from low resonant splitting frequencies to high resonant splitting frequencies when a rotor pole 13 passes a stator pole 7 to generate the required attractive and repulsive forces to maintain rotation.

It can be seen, therefore, that for a given coupling coefficient k, maximum attraction and repulsion forces are developed at low and high resonant splitting frequencies, respectively. For the sake of generating the largest torque on a pole pair 20, it is necessary to operate the electric motor 1 within the effective range at which the coupling coefficient k is greater than the critical coupling coefficient k_{c} and to operate at the varying resonant splitting frequency (f_{L} or f_{H}) that is a function of the coupling coefficient k and the angular displacement. It can be seen from FIGS. 9 and 10 that the power supplied to the stator pole winding 9 (proportional to I₁) and the power picked up by the rotor pole winding 15 (proportional to I₂) are fairly constant over the range from −15° to +15° which implies that there will be fairly near maximum power transfer for the pole pair 20 in the course of rotation.

As discussed, the phase angle between I₁ and I₂ determines the force strength and whether the magnetic forces between the rotor pole 13 and the stator pole 7 are attractive or repulsive. The maximum force will be developed at the phase angle of 0° and 180° whilst no force will be developed at 90°. As shown in FIG. 11, the phase angle is fairly constant in the range of angular displacements from −15° to 0°, and also in the range from 0° to +15°, when the optimal coupling frequencies are used.

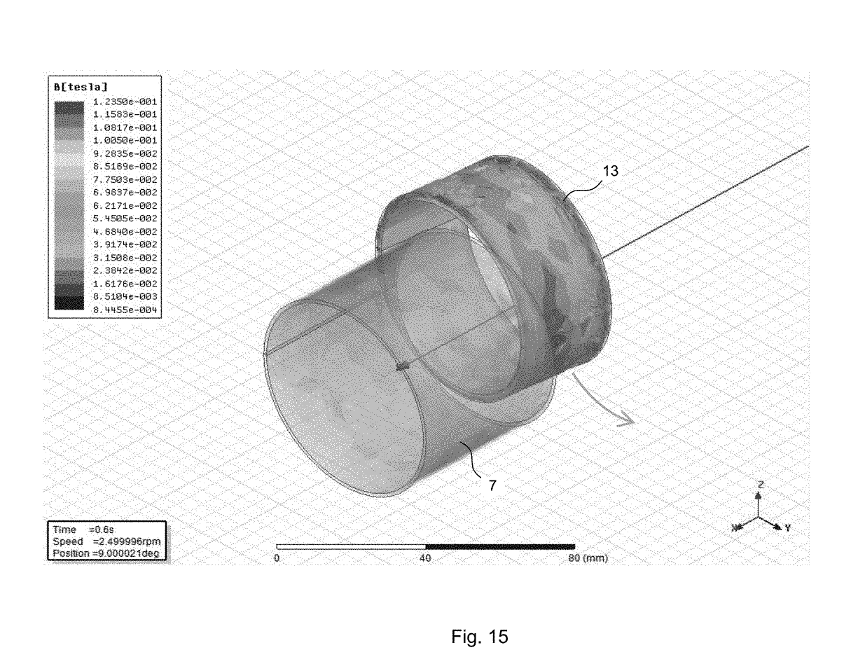

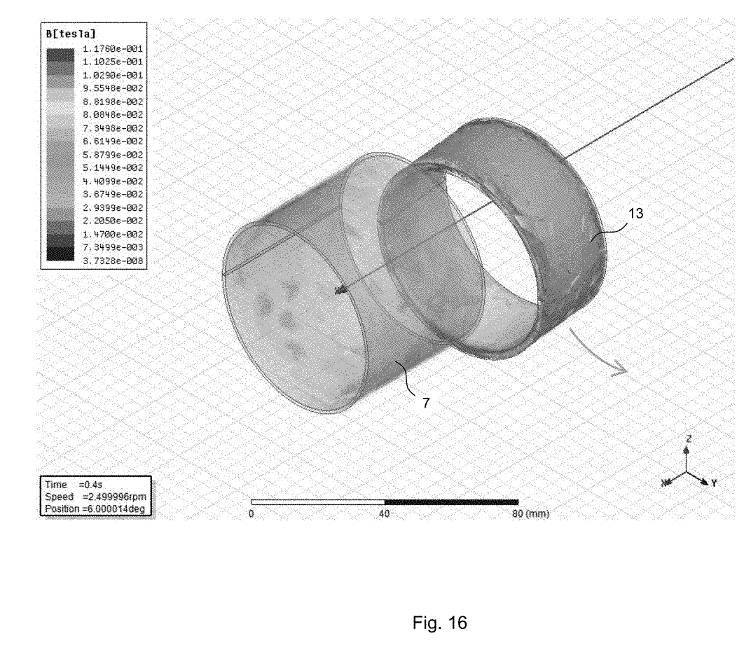

FIGS. 15 and 16 simulate the distribution of magnetic flux on a pole pair 20 using ANSYS Maxwell when the rotor pole 13 is at an angular displacement of −6° and +6°, respectively. FIG. 15 shows the distribution of magnetic flux on a pole pair in an attractive state and FIG. 16 shows the distribution of magnetic flux on a pole pair 20 in a repulsive state.

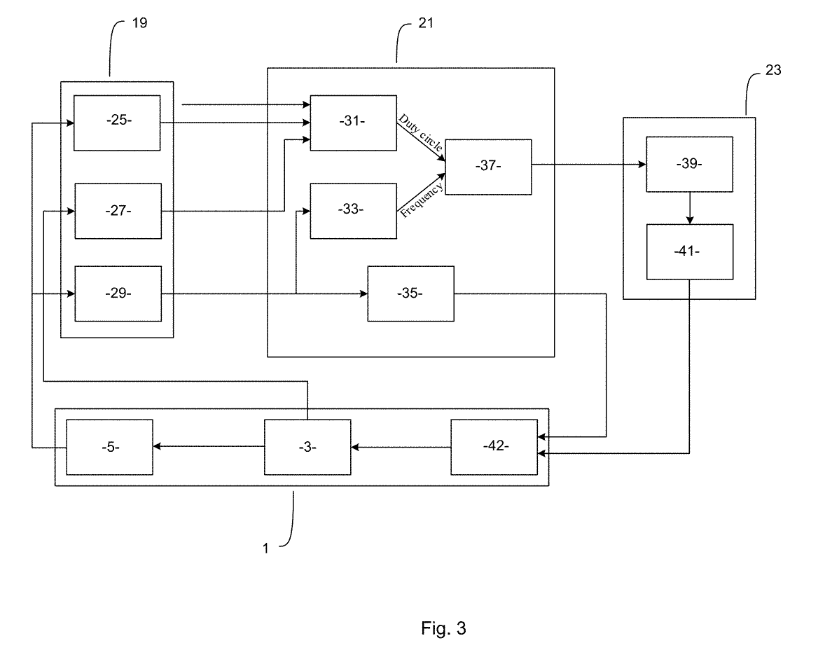

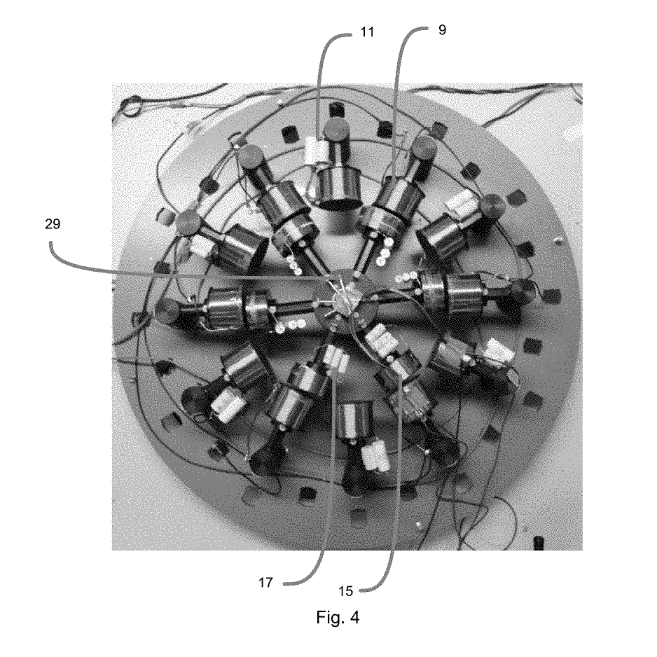

With reference to FIGS. 3 and 4, in a preferred embodiment, the electric motor 1 forms part of an electric motor system which additionally includes a sensor system 19, a control unit 21 and a motor drive 23.

The sensor system 19 comprises a speed sensor 25 associated with the rotor 5 for measuring the speed of rotation of the rotor 5, a current sensor 27 electrically connected to each of the stator pole windings 9 to measure the current flowing through each of the stator coil windings 9 and a position sensor 29 associated with the rotor 5 for determining the position of the rotor salient poles 13 relative to the stator salient poles 7.

The control unit 21 comprises a speed controller 31, a frequency regulator 33, an excitation controller 35 and a pulse width modulation (PWM) generator 37. The speed controller 31 is electrically connected to, and receives a speed signal with rotor speed data from, the speed sensor 25 and is also electrically connected to, and receives a current signal with stator current data from, the current sensor 27. The speed controller 31 is electrically connected to the PWM generator 37 and is operable to determine an error signal from the given speed, determined from the input voltage/current to control the speed of the rotor, and the speed data from the speed sensor 25 and to calculate a duty cycle based on current signal from the current sensor 27.

The frequency regulator 33 is electrically connected to, and receives a position signal with rotor position data from, the position sensor 29 and is operable to calculate the optimal coupling frequency based on the measured position and, hence, angular displacement. The calculated duty cycle and optimal coupling frequency is fed to the PWM generator 37 which is operable to output a PWM signal which is fed to the motor drive 23. The excitation controller 35 is also electrically connected to, and receives a position signal with rotor position data from, the position sensor 29 and is operable to calculate a switch signal for different phases of AC sources.

The motor drive 23 comprises a PWM driver 39 which is electrically connected to an inverter module 41. The output from the PWM generator 37 is fed to the PWM driver 39 and inverter module 41 which are operable to generate a driving signal to be fed to the electric motor.

The electric motor 1 comprises the stator 3 and the rotor 5 as described above and additionally comprises an excitation switch 42 which is electrically connected to each stator salient circuit 12 of the stator 3. The excitation switch 42 is electrically connected to the excitation controller 35 for the receipt of a switch signal output from the excitation controller 35. The excitation switch 42 is also electrically connected to the motor drive 23 for the receipt of the gate driving sources. Combining the gate driving sources from the motor drive 23 with the switch signal from the excitation controller 35, the output from the excitation switch 42 drives the electric motor 1 to operate with the optimum coupling frequencies.

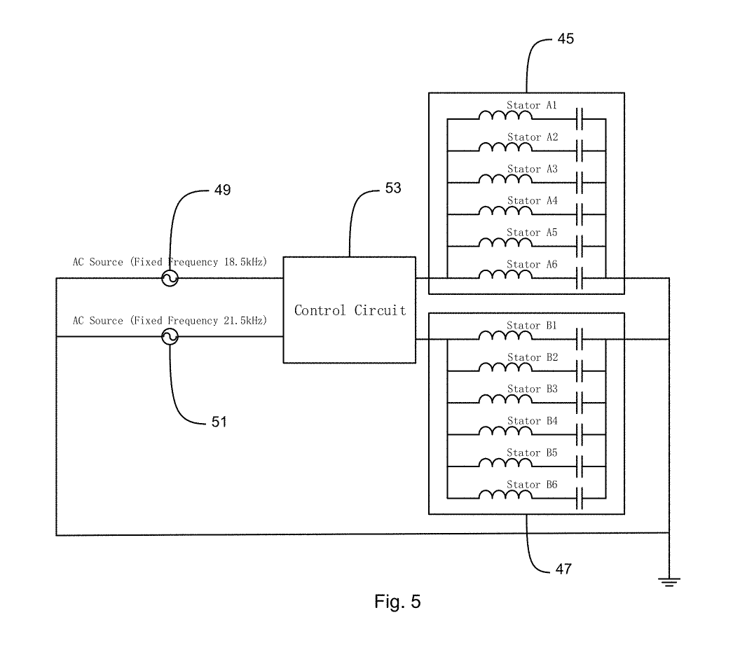

Turning to FIGS. 4 and 5, an experimental setup is shown comprising twelve stator pole circuits 12 which are separated into a first set 45 of six stator pole circuits (designated A1-A6) and a second set 47 of six stator pole circuits (designated B1-B6). The two sets 45, 47 are interleaved such that the stator pole circuits 12 alternate between the first set 45 and the second set 47 around the stator 5 in a sequence of A1, B1, A2, B2 etc. Two AC sources 49, 51 are provided to generate low resonant splitting frequencies or high resonant splitting frequencies. The first AC source 49 is operable at a fixed frequency of 18.5 kHz whilst the second AC source 51 is operable at a fixed frequency of 21.5 kHz. Both AC sources 49, 51 are fed to a control circuit 53 which comprises the sensor system 19, control unit 21 and the motor drive 23. The control circuit 53 is operable to alternately generate a resonant current in the stator pole circuits 12 of the first set 45 and second set 47, respectively depending on the position of the rotor 5 relative to the stator 5. For simplicity, fixed frequencies were used to verify the theoretical operation of the electric motor 1. However, for optimum operation, it is envisaged that the frequency of the alternating current supplied to the respective sets will be varied dependent upon the position of the rotor salient poles 13 relative to the stator salient poles 7 so that the optimum coupling frequencies are generated at each angular displacement.

In operation, when the angular displacement of the rotor salient poles 13 relative to the stator salient poles 7 of the first set 45 is −15°, as determined by the control circuit 53, the control circuit 53 generates a resonant current I₂ in the stator pole circuits 12 of the first set 45 with the optimum low resonant splitting coupling frequency of approximately 19 kHz. At this frequency each rotor pole circuit 19 starts to couple with the adjacent stator pole circuit 12 of the first set 45 and a fair maximum attractive force is developed on each pole pair 20 which pulls the rotor salient poles 13 toward the stator salient poles 7 of the first set 45.

When the angular displacement changes from −15° toward ˜0°, the rotor salient poles 13 are approaching the center line of the stator salient poles 7 of the first set 45. During movement of the rotor 5, the control circuit 43 causes the coupling frequency to decrease from 19 kHz to 17.5 Hz, at each angular displacement with the optimum coupling frequencies, to maintain the maximum attractive force between the rotor salient poles 13 and the stator salient poles 7 of the first set 45. The range from 19 kHz to 17.5 kHz is the frequency band for the attractive force to be developed on each pole pair 20.

When the angular displacement is equal to 0°, the rotor salient pole 13 is substantially aligned with the center line of the adjacent stator salient pole 7, and neither an attractive nor a repulsive force is developed on the pole pair. As the rotor salient poles 13 pass the adjacent stator salient poles 7 of the first set 45, the control circuit 53 changes the frequency of the resonant current in the stator pole circuits 12 of the first set from 17.5 kHz to the high resonant splitting frequency 24.17 kHz, and a repulsive force starts to build up from this moment.

As the rotor salient poles 13 move away from the adjacent stator salient poles 7 of the first set 45 such that the angular displacement changes from 0° toward +15°, the optimum coupling frequency generated by the control circuit decreases from 24.17 kHz to 21 kHz to maximise the repulsive forces between the stator salient poles 7 of the first set and the rotor salient poles 13. The range from 24.17 kHz to 21 kHz is the frequency band for the repulsive force to be developed on a pole pair 20.

When the angular displacement exceeds +15° as determined by the position sensor 25, the control circuit 53 ceases excitement of the rotor salient pole 13 to uncouple the rotor pole circuit 19 from the stator pole circuit 12 of the adjacent stator salient pole 7 of the first set 45. The control circuit 53 then generates a resonant current in the stator pole circuits 12 of the second set 47 at low resonant splitting frequencies to create a new set of resonantly coupled pole pairs and generate an attractive force between the rotor salient poles 13 and the stator salient poles 7 of the second set 47 and the process repeats. Eventually a nearly constant motion torque will be maintained as a result.

It is envisaged that the above electric motor 1 could be incorporated into an electric vehicle to provide torque to propel the electric vehicle. However, it will be apparent to a person skilled in the art that the described magnetic resonant coupling motor could be implemented across a wide range of applications and devices that utilise motors such as household appliances, industrial equipment, toys and other motor based devices.

The above embodiments are described by way of example only. Many variations are possible without departing from the scope of the invention as defined in the appended claims.

1. An electric motor comprising a stator and a rotor, wherein the stator comprises at least one resonant circuit and the rotor comprises at least one resonant circuit rotatable with the rotor relative to at least one stator resonant circuit such that at least one rotor resonant circuit is angularly displaceable relative to at least one stator resonant circuit, wherein at least one stator resonant circuit and at least one rotor resonant circuit are configured to have at least substantially the same self-resonant frequency.

2. An electric motor as claimed in claim 1, wherein at least one stator resonant circuit is operable to generate an alternating magnetic field in response to a supplied alternating current, and wherein the frequency of the alternating current is varied as the angular displacement of a rotor resonant circuit changes relative to a stator resonant circuit.

3. An electric motor as claimed in claim 1, wherein at least one rotor resonant circuit and at least one stator resonant circuit are configured to resonate at two different frequencies above a critical coupling coefficient for each angular displacement, one frequency being a high resonant splitting frequency which is higher than the self-resonant frequency and one frequency being a low resonant splitting frequency which is lower than the self-resonant frequency.

4. An electric motor as claimed in claim 3, wherein a stator resonant circuit and an adjacent rotor resonant circuit are magnetically resonantly couplable to form a pole pair, and wherein an alternating current is supplied to the stator resonant circuit at the low resonant splitting frequency when it is desired to move the rotor resonant circuit toward the stator resonant circuit of the pole pair.

5. An electric motor as claimed in claim 3, wherein a stator resonant circuit and an adjacent rotor resonant circuit are magnetically resonantly couplable to form a pole pair, and wherein an alternating current is supplied to the stator resonant circuit at the high resonant splitting frequency when it is desired to move the rotor resonant circuit away from the stator resonant circuit of the pole pair.

6. An electric motor as claimed in claim 4, wherein the frequency of the alternating current is adjusted during operation of the electric motor according to the angular displacement of the rotor resonant circuit relative to the stator resonant circuit of the pole pair.

7. An electric motor as claimed in claim 1, comprising a plurality of stator resonant circuits each configured to have at least substantially the same self-resonant frequency.

8. An electric motor as claimed in claim 1, comprising a plurality of rotor resonant circuits each configured to have at least substantially the same self-resonant frequency.

9. An electric motor as claimed in claim 1, wherein the stator comprises at least one stator salient pole and the rotor comprises at least one rotor salient pole, and wherein each stator salient pole is associated with a stator resonant circuit and each rotor salient pole is associated with a rotor resonant circuit.

10. An electric motor as claimed in claim 9, wherein each stator resonant circuit comprises a winding and a capacitor, each winding being wound around a corresponding stator salient pole in the same direction.

11. An electric motor as claimed in claim 9, wherein each rotor resonant circuit comprises a winding and a capacitor, each winding being wound around a corresponding rotor salient pole in the same direction.

12. An electric motor as claimed in claim 1, comprising a plurality of stator resonant circuits and a plurality of rotor resonant circuits, and wherein each rotor resonant circuit may be arranged relative to a stator resonant circuit to form a pole pair which is magnetically resonantly coupled.

13. An electric motor as claimed in 11, wherein the plurality of stator resonant circuits are divided into two or more sets which are interleaved, and wherein the two or more sets are alternately energised depending on the angular displacement of the rotor resonant circuits relative to the stator resonant circuits.

14. An electric motor as claimed in claim 1, wherein one or more rotor resonant circuits are closed circuits and/or more than one rotor resonant circuit together forms a closed circuit.

15. An electric motor system comprising an electric motor; a sensor arrangement; and a drive circuit arrangement; wherein the electric motor comprises a stator and a rotor, wherein the stator comprises at least one resonant circuit and the rotor comprises at least one resonant circuit rotatable with the rotor relative to at least one stator resonant circuit such that at least one rotor resonant circuit is angularly displaceable relative to at least one stator resonant circuit, wherein at least one stator resonant circuit and at least one rotor resonant circuit are configured to have at least substantially the same self-resonant frequency; the sensor arrangement is operable to measure the position of the rotor relative to the stator; and the drive circuit arrangement is operable to generate a drive signal based upon the measured position to drive the electric motor.

16. An electric motor system as claimed in claim 15, wherein the sensor arrangement is further operable to measure the speed of rotation of the rotor and/or the electric current supplied to each stator resonant circuit.

17. An electric motor system as claimed in claim 15, wherein the drive circuit is operable to vary the frequency of the alternating current supplied to one or more stator resonant circuits depending on the measured position of the rotor relative to the stator.

18. An electric motor system as claimed in claim 15, wherein the electric motor comprises a plurality of stator resonant circuits and the drive circuit is operable to energise one or more stator resonant circuits at different times during operation of the electric motor depending on the measure position of the rotor relative to the stator.

19. A vehicle comprising an electric motor as claimed in claim 1.

20. A method of operating an electric motor which comprises a stator having at least one resonant circuit and a rotor having at least one resonant circuit, wherein at least one stator resonant circuit and at least one rotor resonant circuit are configured to have substantially the same self-resonant frequency, the method comprising the steps of: energising a stator resonant circuit at a frequency to generate a resonant current in an adjacent rotor resonant circuit and varying the frequency depending on the angular displacement of the adjacent rotor resonant circuit relative to the stator resonant circuit.

21. A method as claimed in claim 20, wherein the frequency is a low resonant splitting frequency which is below the self-resonant frequency when it is desired to create an attractive force between at least one stator resonant circuit and an adjacent rotor resonant frequency to force the rotor to rotate in a direction toward the stator resonant circuit.

22. A method as claimed in claim 20, wherein the frequency is a high resonant splitting frequency which is above the self-resonant frequency when it is desired to create a repulsive force between at least one stator resonant circuit and an adjacent rotor resonant frequency to force the rotor to rotate in a direction away the stator resonant circuit.

23. A method as claimed in claim 22, wherein the frequency is changed from below the self-resonant frequency to above the self-resonant frequency when a rotor resonant circuit passes a stator resonant circuit.

24. A method as claimed in claim 23, wherein each stator resonant circuit comprises a winding having a longitudinal axis and each rotor resonant circuit comprises a winding having a longitudinal axis and wherein a rotor resonant circuit passes a stator resonant circuit when the longitudinal axis of the rotor resonant circuit passes through the longitudinal axis of the stator resonant circuit.

25. A method as claimed in claim 20, further comprising measuring the position of the rotor relative to the stator and varying the frequency depending on the measured position.

26. A method as claimed in claim 20, for an electric motor comprising a plurality of stator resonant circuits, the method further comprising the steps of: energising a first stator resonant circuit when a rotor resonant circuit is at a position which is closer to the first stator resonant circuit than an adjacent second stator resonant circuit which is not energised, and ceasing to energise the first stator resonant circuit and energising the adjacent second stator resonant circuit when the rotor resonant circuit is at a position which is closer to the second stator resonant circuit than the first stator resonant circuit.

27. A method as claimed in claim 26, wherein the second stator resonant circuit is energised and the first stator resonant circuit is de-energised when the rotor resonant circuit moves beyond a position which is equidistant between the first stator resonant circuit and the second stator resonant circuit.
